(19) United States
(12) Patent Application Publication
(10) Pub. No.: US 2006/0109964 A1
(43) Pub. Date: May 25, 2006

(54) System and method for matching shippers and carriers

(76) Inventor: John L. Skelton, Greenbank, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/260,873

(22) Filed: Oct. 27, 2005

Related U.S. Application Data
(60) Provisional application No. 60/622,823, filed on Oct. 28, 2004.

(51) Int. Cl. H04M 15/00

(52) U.S. Cl. 379/114.02

(57) ABSTRACT

A method and system for electronically matching shipper user requests for motor vehicle transport companies (carriers) who meet the criteria needed for transporting such motor vehicles via a web-based application utilizing web structures (visitor and referral tracking, membership and account management, billing and invoicing, electronic commerce, and back-office management tools) and a unique post-bid mechanism that functions similar to a reverse electronic auction. Shippers create an account and enter load details into the system for carriers to bid on. Each load can be set with an expiration date and deadline for bid submission. Carriers create an account and pre-determined profile describing their services, at which point the system will match carriers with the shipper's load details (based on their profile) and notify each carrier that it can place a bid to transport that load of motor vehicle(s). Any qualified carrier can then place one bid on each load of automobiles it is qualified to carry. The shipper of the automobiles will, either at the expiration date and time or upon terminating the bidding early, select the most qualified bid from the list of resulting bids and enter into an agreement with the carrier submitting the bid. Should that carrier accept the agreement, the load of automobiles is then awarded to that carrier for transport.

### BACKGROUND OF THE INVENTION

1. Field of the Invention

This invention related to an Internet-based system for electronically matching loads of motor vehicles between those who wish to ship them and those who might transport them. Based on a ‘reverse auction’ concept, the loads will be bid on by carriers and the lowest or best bid will be accepted by shippers.

2. Description of the Related Art

Description of the Related Art: In the field of motor vehicle transporting, a typical transaction between a shipper, e.g., one who wishes to ship vehicle(s), and a carrier, e.g., one who may be hired to transport the motor vehicle(s), usually requires the shipper to have direct communication with many different carrier sales representatives or dispatchers by phone, facsimile, electronic mail and/or in person to determine the carrier's rate and schedule, e.g., date of pick up. This is because carriers have varying rates and irregular routes with no set schedules, and shipper information on available carriers is not widely available to bring the parties together. Similarly, shippers generally have no marketplace for publicizing their motor vehicle transport needs to motor vehicle carriers on the open market. This situation exists for both business and individual private shippers to carrier.

A shipper typically spends endless hours matching a carrier to the motor vehicle(s) to be shipped. Once the shipper has matched their motor vehicle(s) to a carrier, transfer of data details from shipper to carrier quite often are transposed, presenting costly and timely errors for both the shipper and the carrier. With no marketplace for the carrier to view, quite often the carrier must relocate its equipment, incurring high costs and loss of time. This poor equipment utilization also contributes to environmental pollution as well. Additionally, when a shipper hires a carrier, the shipper has no easy way of finding information regarding the carrier's ability to perform the transaction in a safe and timely manner. After the carrier has been given authorization from the shipper to handle the transaction, the shipper does not have the ability to simply track the whereabouts of their motor vehicle(s). For individual private shippers to acquire the use of a motor vehicle transport carrier, they usually unknowingly end up contacting a broker listed under the ‘Auto Transport’ section in the Yellow Pages of the phonebook as opposed to an actual carrier, which results in the private shipper incurring a large broker fee—anywhere from 10 to 50 Percent of the cost of the transport. And once the broker has placed the motor vehicle(s) with a carrier, the private shipper—in most cases—is not able to track their motor vehicle(s) through the broker and does not know how to contact the carrier directly.

If similar information were to become available to the vehicle shipping industry on a large-scale, significant savings in time and expense to both shippers and carriers could be realized. In addition, shippers would have carrier statistics available to them prior to assigning motor vehicle(s) to a carrier and would have the ability to track their motor vehicle(s) available to them.

### BRIEF SUMMARY OF THE INVENTION

Briefly, in accordance with one aspect of the invention, carriers register in the system and must meet certain criteria to be accepted in the system for opportunities to bid on a load of automobiles to be transported. Carriers can manage certain aspects of their accounts online through a web-based interface.

In accordance with another aspect of the invention, shippers register in the system and must meet certain criteria to be accepted as an organization that has automobiles to ship from one location to another. Shippers receive bids from automobile carriers to ship those loads. Shippers can manage certain aspects of their accounts online through a web-based interface.

In accordance with another aspect of the invention, shippers post loads of one or more automobiles in the system using an online web-based interface. Loads have a start and end bid date and time. Once a load is posted, the database searches the carrier records for carriers that match the criteria of the load including start and end destinations and date and time ranges of pickup and delivery. Frequent searches will be conducted daily between the start date and time, and the end date and time for bids. When matching carriers are found in the database, each matching carrier will be notified by electronic mail that there are loads requesting a bid.

In accordance with another aspect of the invention, carriers who are notified about loads to be bid on can enter the system and place one bid for each load requesting a bid using a web-based interface. When a bid is submitted, the shipper of the load will be notified by electronic mail that a bid has been submitted for the load. That shipper can then return to the system to check the status of the bidding for any of the shipper's posted loads. Shippers can let the bid auction continue until it is finished or may elect to end the bidding opportunities early.

In accordance with another aspect of the invention, once the auction period is expired or otherwise ended by the shipper, any carrier that had been notified about the bidding opportunity will be notified by the system in an electronic mail that the time period has expired. Those carriers who posted bids will be informed that their bid has been received and is being reviewed by the shipper. The shipper will analyze each bid using a web-based interface and select the winning bid based on price and pickup and delivery timeframes. The selected carrier will be notified by electronic mail that its bid is the selected bid.

In accordance with another aspect of the invention, the selected carrier must return to the system and, using a web-based interface, either accept or decline the agreement to transport the shipper's load. This is done because there may be an extended timeframe between submission of the bid against the load and the award, and this can give the carrier an opportunity to ‘overbook’ its transport. If the agreement is accepted, the shipper is again notified with an electronic mail that the carrier has agreed to transport the load. An agreement is put in place and all shipping documents are generated so the carrier can print them out and use them in its process. If the agreement is declined, the shipper is notified that the selected carrier is overbooked and has declined the load; the bid is then removed from the list of bids; and the shipper must return to the system to select another bid from the remaining bids that were submitted. This process continues until either the load is accepted by a carrier or there are no longer any valid bids in the list. If this should occur, the shipper uses the web-based interface to re-post the load for possibly a different length of time to gather more bids to select from.

Briefly in accordance with another aspect of the invention, carriers can return to the system and indicate a running status of the shipper's load once it has been awarded to them. The status will allow the shipper to track the load as it travels from the pickup point to the delivery point.

Briefly in accordance with another aspect of the application, shippers and carriers (users) are provided a feedback tool that will result in a grade or rating for each user. The system will combine grade reports against each user that will result in a current grade for that user based on feedback from other users who have also done business with the graded user.

In accordance with another aspect of the invention, both shippers and carriers (customers) receive monthly invoices for the service, depending on their account types and the billing cycles associated with those account types. Billing is handled on a base rate plus a per-automobile basis with the base rate covering a pre-determined number of automobiles in each load posted per month. The database job engine determines which accounts are due an invoice, how the customer wants to be invoiced (paper, electronic mail, facsimile, etc.), and then generates the appropriate invoices. In the event of paper invoices, a batch will be set up and the proper administrative personnel will be notified by electronic mail that a batch of invoices is awaiting printing. Invoices can be collected either by the customer sending a check or card information in the mail or by the customer paying online with a credit/debit card or electronic check, transaction using a web-based interface.

### BRIEF DESCRIPTION OF THE SEVERAL VIEWS OF THE DRAWINGS

The foregoing features and advantages of the disclosed embodiments of the invention will be more readily appreciated as the same become better understood from the following detailed description when taken in conjunction with the accompanying drawings, wherein:

FIG. 1 illustrates the general operation and architecture of the Internet, across which the disclosed embodiments of the invention are implemented.

FIG. 2 illustrates a block diagram of the system operating using the Internet to deliver the application to users in accordance with the entire invention.

FIG. 3 illustrates the major entities included and addressed in accordance with the entire invention.

FIG. 4 illustrates the account management system in accordance with one aspect of the invention FIG. 5 illustrates the Auction/Bid/Agreement/Award system in accordance with one aspect of the invention.

FIG. 6 illustrates an extension of the Auction/Bid/Agreement/Award system in accordance with one aspect of the invention.

FIG. 7 illustrates the invoicing process in accordance with one aspect of the invention.

FIG. 8 illustrates the load tracking process in accordance with one aspect of the invention.

FIG. 9 illustrates the user grading system in accordance with one aspect of the invention.

### DETAILED DESCRIPTION OF THE INVENTION

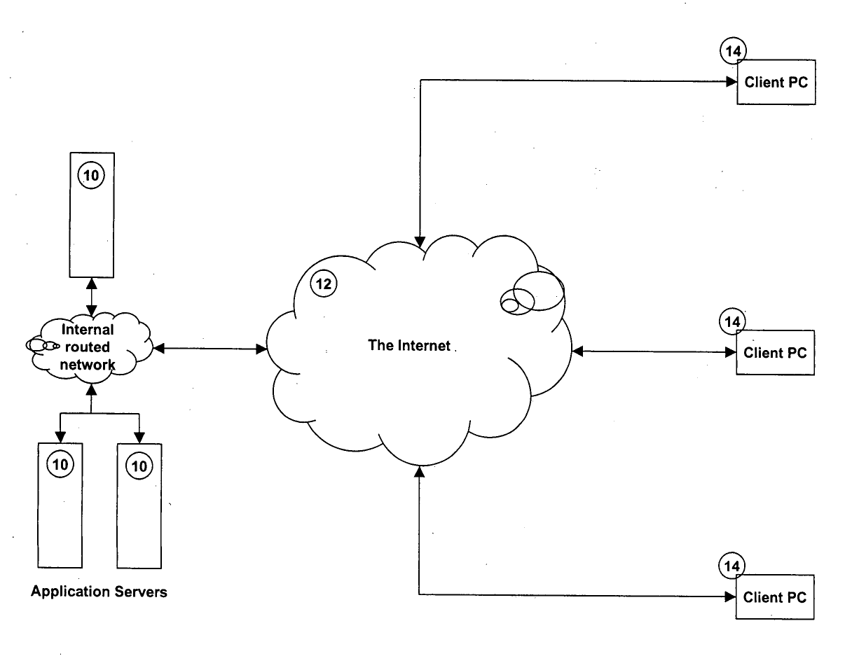

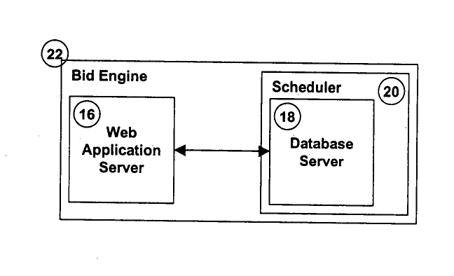

FIG. 1 is a diagram depicting in general an overview of one system 10 formed in accordance with the present system. As shown therein, the system 10 includes a plurality of hosting servers 11 coupled to the Internet 12 through an internal routed network 13 and thence to the requesting client's computer system 14. It is to be understood that while this embodiment of the invention is described for use with the Internet 12, the system can be implemented on a private IP routed network.

FIG. 2 illustrates key aspects of a bid engine 22 of the system 10, which includes a web application server 16 that provides all of the communication from the server, on which the application resides, 11 to the requesting client 14 and back to the server. The system delivers the assembled application to the client 14, compiles and executes server-side application code, and handles communication from between the client 14 and to the server 10 via (HyperText Transfer Protocol) HTTP version 1.1. The database server 18 provides the database management engine and stores all of the application data, including user records, system logs, and bid data, that the system uses. The scheduler 20 is an integral part of the database server 18 and will handle all of the scheduled tasks required by the system 11. The bid engine 22 handles all bidding against posted loads and is a combination of code compiled and executed by the web application server 16 and tasks run by the scheduler 20.

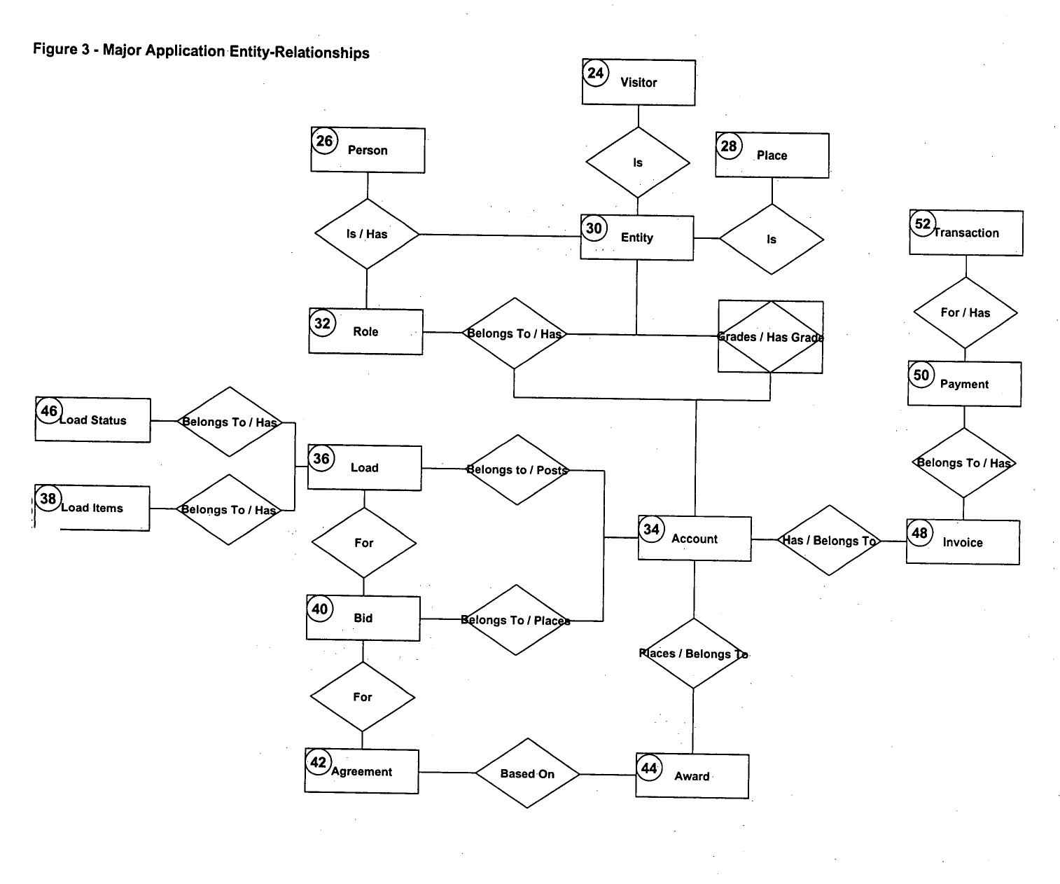

FIG. 3 illustrates, in industry standard entity relationship notation, what major entities participate in the system. A visitor 24 is any visitor to the system's web-based application—or website. Visitors 24 are people operating web browsers via a client computer. An entity 30 is a human or a non-human entity that plays a role, other than just the casual visitor 24, in the system. All entities 30 are registered within the system through the system's registration process. A person 26 is a human entity 30 and a place 28 is a non-human entity 30 such as a company. Each person 26 has a role 32 in the system. An account 34 is a combination of one non-human entity 30 and one or more human entities 30. The account 34 is the core of the system and that upon which everything is based upon. An account 34 can be invoiced 48 and can post a load 36—made up of one or more load items 38, and can bid 40 on posted loads 36. When an account 34 selects a bid 40 for the load 36 the account 34 has posted, the account 34 posting the load 36 and the account 34 bidding on the posted load 36 will enter into an agreement 42 for the bidding account 34 to handle the load 36 and the account 34 that has posted the load 36 will award 44 the load 36 to the winning account 34. After the account 34 handling the load 36 picks it up, that account 34 will ensure that it maintains load status 46 in the system so that the account 34 owning the load 36 can determine by using the system where the load 36 is currently located at any given time. Finally, if the account 34 is a paying account, an invoice 48 is generated on the desired schedule and provided to the account 34 by the desired method (physical mail, electronic mail, or facsimile). The account 34 responsible for satisfying the invoice 48 can make payment 50 by check (physical paper or electronic) or with a debit/credit card using one or more transactions 51.

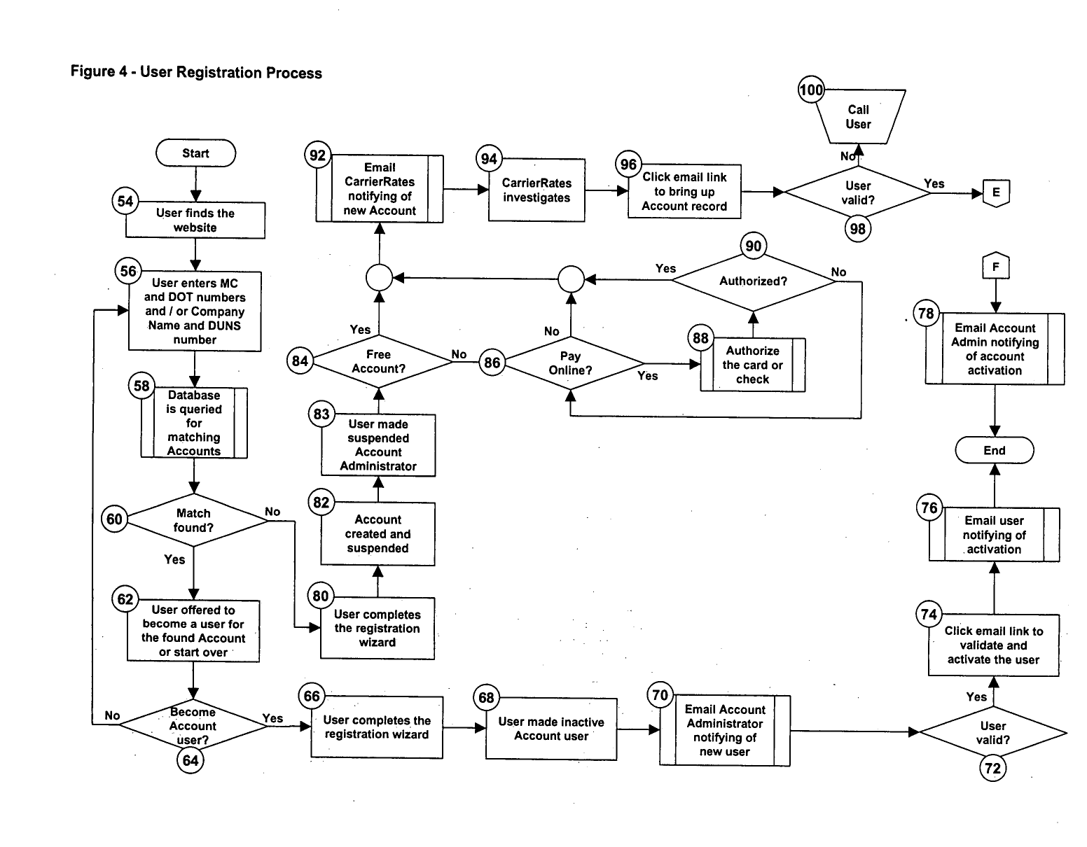

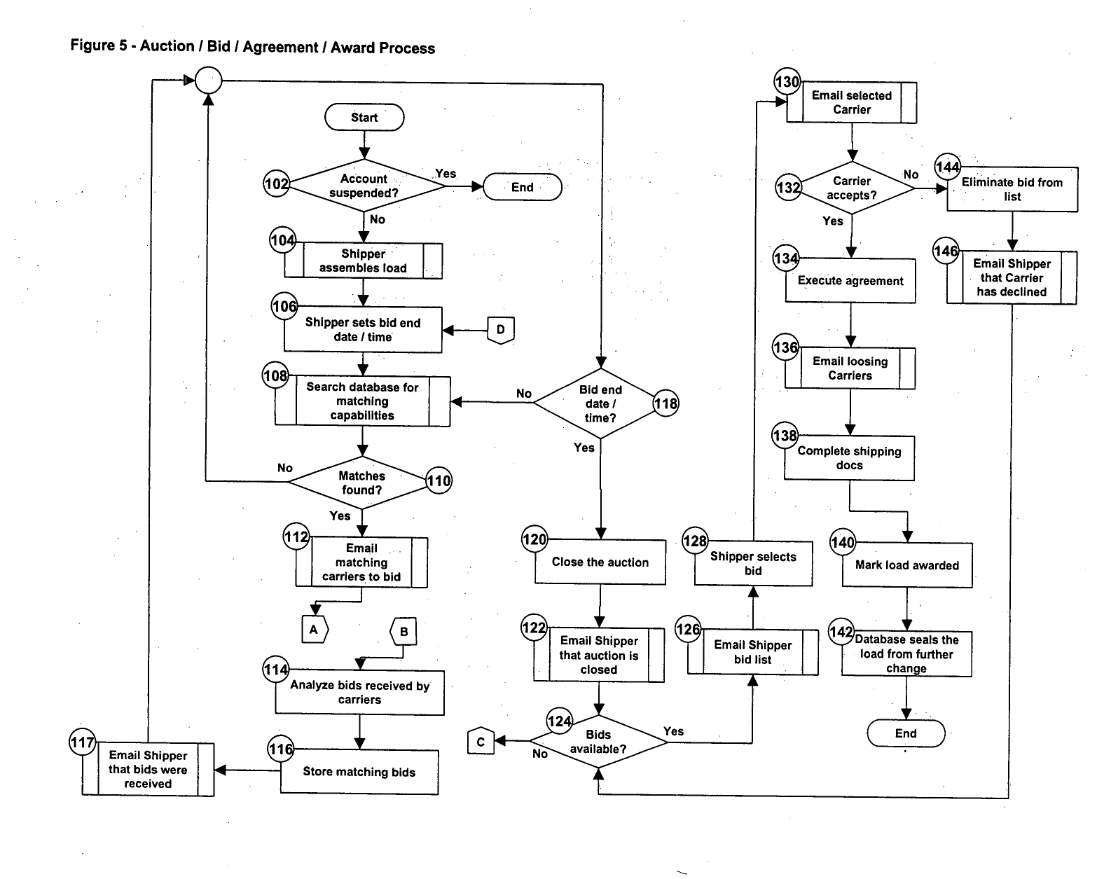

FIG. 4 illustrates, in industry standard flow charting notation, how a visitor 24 registers for an account 34 using the system. Depending on the type of visitor 24, they will provide different types of identifying information to the system. Upon submission of the visitor's information into the system, the database will be queried to see if this visitor 24 might already have an account 34 in the system. If it is found that the visitor 24 is already a registered account 34 holder, he or she will be offered the opportunity to log on to the system. If the visitor's company is already registered but the visitor 24 is not a registered user under that company's account 34, the visitor 24 will be offered an opportunity to become a member of that company's account 34. Should the visitor 24 agree to become a member of the existing company's account 34, the visitor 24 will complete the registration information form and submit it to the system. The system will make that visitor 24 an inactive member of the company's account 34 and an email will be sent to the company account 34 administrator asking him or her to validate this new visitor 24. Once validated, the visitor 24 will be sent an email welcoming him or her to the company's account 34 as a user.

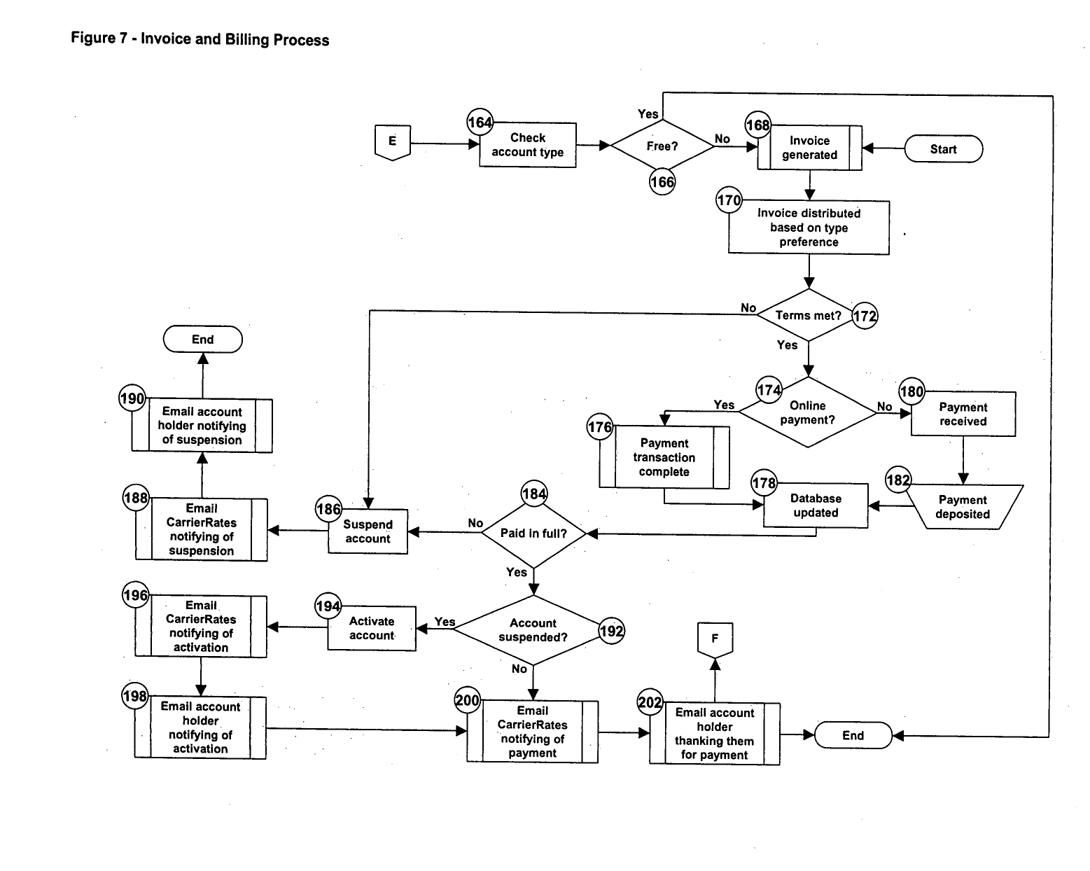

Visitor's 24 will find the system's website through various means such as online search engines, word of mouth, or corporate direction 54. If the visitor 24 is a shipper of motor vehicles the visitor 24 will provide the company name and DUNS number to the system through the registration process 56. If the visitor 24 is a carrier of motor vehicles the visitor 24 will provide a US DOT Number, and MC Number, and a company name to the system through the registration process 56. Once the visitor 24 submits the information to the system, the system's database will search 58 for a company with a matching set of criteria (DUNS number or MC Number depending on whether the visitor 24 is from a shipper or from a carrier) and company name. Should the database find that the visitor 24 is from a company that does not exist in the system 60; a new account 34 will be established with the visitor 24 as the account 34 administrator 80. Both the account 34 and the visitor 24 will be suspended 82, 83 until the account 34 background can be investigated and determined, through a manually performed process 100, to be from a valid source. If the account 34 type is a paid account type 84, payment will be collected either online 86, 88 or through an invoice 168 depending on the visitor's 24 selected payment and billing preference. If, through the manually performed process 100 the visitor 24 and the company are validated, the account 34 will be activated, removing the suspension from the account and the visitor. FIG. 7 indicates, in industry standard flow charting notation as a continuation of FIG. 4, the invoice and payment process that services the entire scope of the system. After the account has been validated, a payment process will be executed following the steps outlined in FIG. 7.

FIG. 7 illustrates, in industry standard flow charting notation, the process followed for all invoicing and invoice payments in the system. The account type is checked 164 to determine if there is a charge for it. If there is a charge for the account type 166 and invoice is generated based on the account 34 holder's invoicing preference. Depending on invoice type preference, the invoices are distributed 170.

When the payment is received against the invoice the system checks to see if the payment terms have been met 172. If the terms have not been met the account 34 is suspended 186 and email is sent to the system management 188 and the account 34 holder 190 indicating what needs to happen to ensure the account 34 is paid in full and the suspension lifted. If the terms have been met and an online payment is used 174 the selected online payment process component will be employed to complete the transaction 176 and the system's database is updated 178 to reflect the current payment. In the event a manual payment is received 180, it will be deposited in the bank manually 182 and the database will be updated 178 to reflect the current payment.

Once the database is updated 178 the account 34 will be looked at by the database to determine if it is paid on full or not 184. If the account has not been paid in full 184, the account 34 is suspended 186 and email is sent to the system management 188 and the account 34 holder 190 indicating what needs to happen to ensure the account 34 is paid in full and the suspension lifted. If the account 34 has been paid in full and the account has been suspended 192, the database will activate the account 194 and email is sent to the system management 196 and the account 34 holder 198 indicating that the account has been activated, and email is sent to the system management 200 and the account 34 holder 202 indicating that the account has been paid in full.

FIG. 5 illustrates, in industry standard flow charting notation, the process for placing loads 36 of motor vehicles on the system and bidding 40 to carry said loads 36 of motor vehicles from a start point to a destination. A shipper will visit the system through the web-based interface, log on with his or her credentials, and assemble 104 one or more loads 36, each containing one or more motor vehicles or load items 38. Using the system's user interface, the visitor 24 will enter the location the load 36 will be picked up and the location the load 36 is destined for, and a range of times and dates that the load 36 can be picked up and delivered. The visitor 24 will then enter one or more vehicles, up to ten, into each load 36 by selecting make, model, year, number of doors, trim package, and entering the Vehicle Identification Number (VIN) of each vehicle in the load along with a unique reference number of the shipper's choice e.g., rental car number, auction number, dealership stock number, etc. 36. Once the load is assembled 104, the visitor will set how long the bidding 40 will remain active 106 on this load 36. Finally, the visitor 24 will submit the load to the system's database for advertisement and bidding on by carriers of motor vehicles who are also registered users of the system. Preferably, several times over the course of each hour of each day the database scheduler 20 will start a search of the records for qualified carriers 108 who have the right capabilities and qualifications to carry the submitted load 36 of motor vehicles. Matching criteria include whether the carrier services both the start point and the destination, if the carrier has the proper type of carrier requested by the shipper, and if the carrier has a valid insurance certificate. Each matching motor vehicle carrier that is found during the search 110 will be notified 112 by email that they are invited to bid 40 on the load 36.

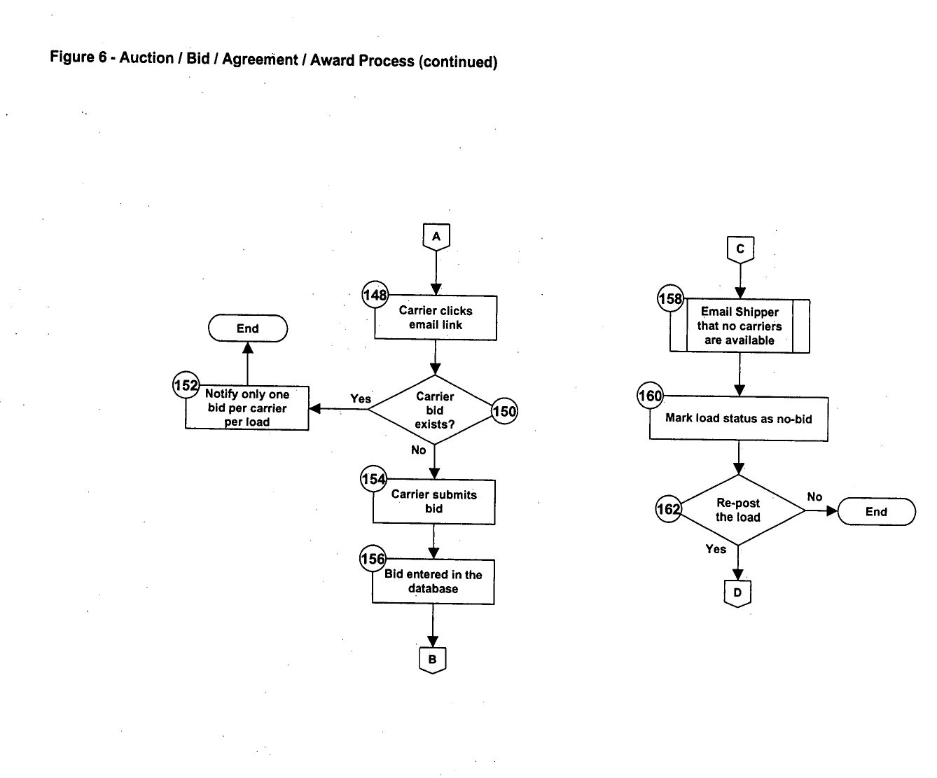

FIG. 6, in industry standard flow charting notation, continues this notification process and shows the notified carrier clicking a link provided in the notification email 148 that will carry him or her back to the system via the Internet as a visitor 24. After logging on with his or her credentials, the load that the visitor 24 is being asked to bid on will be displayed. If a bid 40 already exists from the visitors company 150 at the time of the visit the visitor 24 will be unable to place a bid 40 but can view the bid currently against the load 36 and the visitor 24 will be notified on the screen that only one bid 40 is allowed per carrying company. If a bid 40 has not yet been placed by the visitor's 24 company 150, the visitor will have the opportunity to place a monetary bid 40 against the load 36. If the visitor 24 elects to submit a bid 40, the bid is submitted 154 through a form on the system and then it is stored in the system's database 156. Upon receipt of a bid 40 from a carrier, the system's database will again analyze the bid 40 and the bidding carrier's profile (ensuring nothing has changed) since the bid was offered 114. If the bid still meets the original criteria then the bid is stored in the database 116 and the shipper is notified by email that a bid has been received for his or her load 117.

On a schedule of preferably at least once an hour of each day, and ideally 3 to 6 times an hour, the database scheduler 20 will analyze all of the active bids in the database and determine if the bidding 40 timeframe has expired 118. If the bidding timeframe has not yet expired, the search process in item 108 will be repeated for all loads 36 where the bidding 40 timeframe has not expired. If the bidding 40 timeframe has expired, the database will close 120 the bidding 40 on all loads 36 where the bidding 40 timeframe has expired. Shippers with loads 36 where bidding 40 is being closed will be notified by email that the bidding period has expired 122. If bids 40 are not available for a load 36 after the bidding 40 has stopped 124, FIG. 6 shows that the shipper who submitted the load 36 will be notified by email 158 that no carriers have provided a bid 40 on the load 36. The database-will then mark the status of the load 36 as a no-bid load 36. The shipper can then elect to repost the load 36 by re-setting the bid timeframe 106.

If bids 40 are available for the load 36 after the bidding 40 timeframe has expired 124, the shipper will be notified by email 126 that one or more bids have been received by the system for the shipper's load 36. The shipper will follow a link in the notification email back to the system as a visitor 24 and will then be able to examine all bids and then select 128 one of the submitted bids 40 using the bid selection tool in the system. Once a bid 40 is selected by the visitor 24, the carrier submitting the bid is notified by email 130 that their bid 40 has been selected by the shipper. The notified carrier will follow a link in the notification email back to the system as a visitor 24, and the carrier must either accept or decline 132 the load 36. If the visitor declines the load 36, the visitor's bid 40 is removed 144 from the list of bids 40 placed against the load 36 and the shipper of the load 36 is notified by email 146 that the selected carrier has declined the load 36. If there are other bids 40 available against the load 36, the email will also instruct the shipper to return to the system, following a link as a visitor 24, and select another bid 128 from the remaining bids. If the carrier who has followed the link in the notification email back to the system as a visitor accepts 132 the load 36, then the visitor is asked to agree to the load 36 by executing an agreement 134 with the shipper. Upon execution of the agreement 134, the system will email 136 all of the other carriers who have submitted bids 40 for the load 36 that the load 36 has been awarded 44, 140, and all of the shipping documents will be created for printing 138 by the visitor 24. Finally, the system's database will seal 142 the load 36 from any further change by marking it as awarded 44.

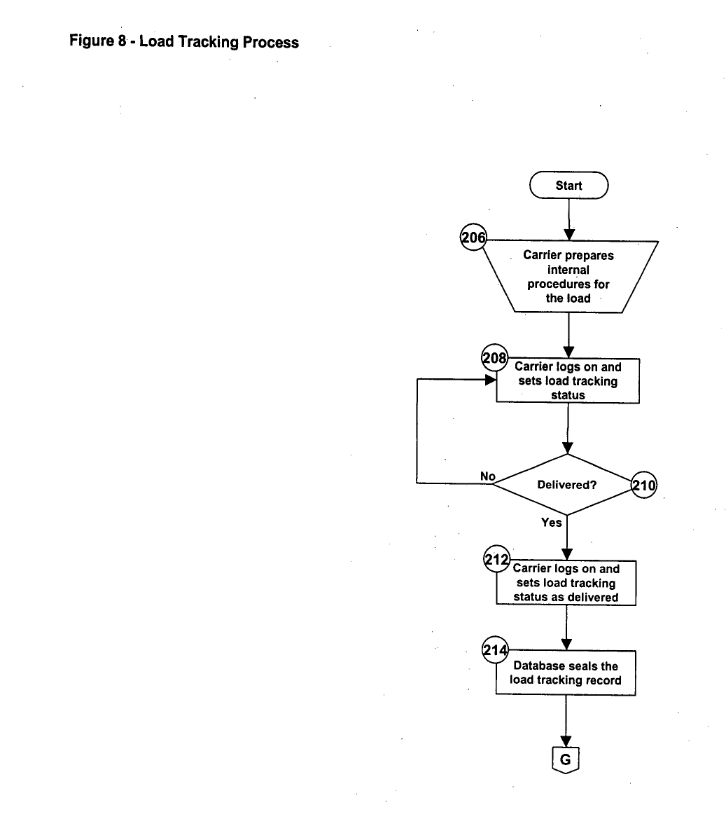

FIG. 8 illustrates, in industry standard flow charting notation, the process of the load-36 carrier keeping a record of where the load 36 is currently at and what the status of the load 36 is. After accepting the award 44 a carrier prepares 206 using his or her own internal procedures to pick up and transport the load 36. Once the load 36 has been physically picked up at it's start point the carrier will return to the system as a visitor 24 and set the status 208 fore the load 36 as ‘picked up’. Frequently, throughout the transport the carrier will return to the system as a visitor and update the status 210, 208 of the load 36. When the load is delivered to its destination, the carrier will return to the system as a visitor 24 and set the status 212 for the load 36 as ‘delivered’. Once this status is entered into the system's tracking system the database will seal the tracking record from any further changes 214. Sealing this status record will start the process by which both the shipper and the carrier rate each other on their performance.

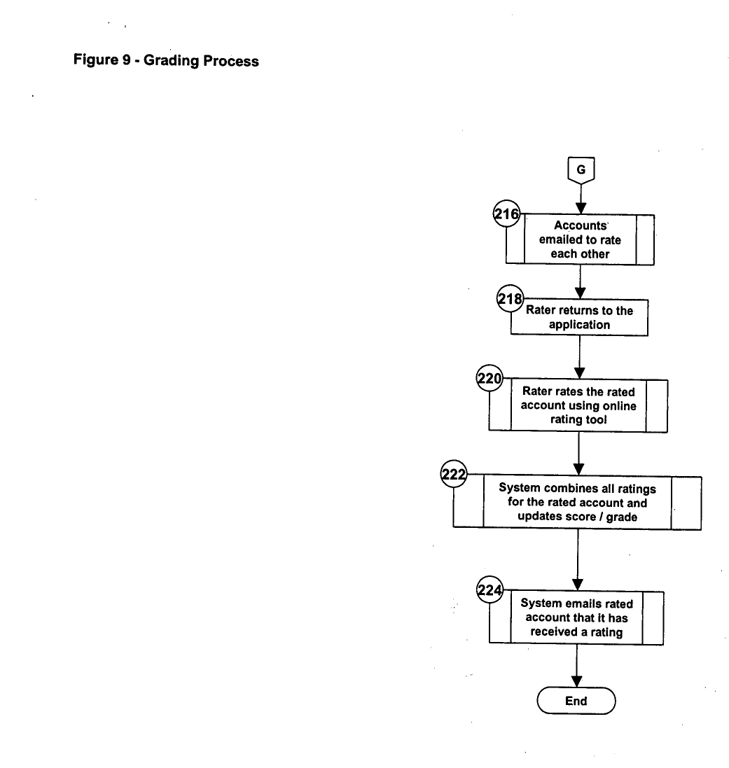

FIG. 9 illustrates, in industry standard flow chart notation, how the grading process works. The system will provide a grading system that will show how easy each carrier and shipper is to work with, how prompt payment is, how courteous personnel are, and what the overall quality of the experience was. When the load status 46 for a load 36 has been marked as delivered, this will initiate email notifications to both the shipper and carrier accounts 216 inviting each to return to the system as visitors 24 and grade each other. Following a link in the notification email back to the system 218 as a visitor 24, the visitor will complete a yet-to-be-determined and always changing set of feedback items that will provide a numerical score for the account 34 being rated 220. When the visitor 24 submits the grade to the system, the database will calculate a numerical score for the rated account 34 based on previously submitted grades as well as this one and upgrades 222 the account's 34 grade. Once the account has received it's new grade, the account being graded will be notified by email 224 that it has been graded by the visitor's 24 account 34.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A system for matching shippers and carriers, comprising:
means for receiving and storing shipment data in a database regarding shipments to be delivered; and
means for receiving bids from carriers on shipments to be delivered and means for shippers to select bids from carriers and contract for delivery of the shipments.

2. The system of claim 1, further comprising means for receiving and storing information from carriers regarding status of shipments to be delivered by the carriers.

3. A method for matching shippers and carriers, comprising:
providing shippers electronic access to a database;
receiving and storing shipment data in the database regarding shipments to be delivered;
providing carriers access to the database and receiving and storing carrier data in the database; and
providing means for carriers to bid on shipments to be delivered and means for shippers to select bids from carriers and contract for delivery of the shipments.

4. The method of claim 3, further comprising receiving and storing information from carriers regarding status of shipments to be delivered.
